(19) United States
(12) Patent Application Publication
(10) Pub. No.: US 2013/0117174 A1
(43) Pub. Date: May 9, 2013

(54) REAL-TIME MICROFINANCE

(71) Applicants: Alan G. Cole, Katonah, NY (US); Herbert S. McFaddin, Yorktown Heights, NY (US); Chandrasekhar Narayanaswami, Wilton, CT (US); Justin D. Weisz, Stamford, CT (US)

(72) Inventors: Alan G. Cole, Katonah, NY (US); Herbert S. McFaddin, Yorktown Heights, NY (US); Chandrasekhar Narayanaswami, Wilton, CT (US); Justin D. Weisz, Stamford, CT (US)

(73) Assignee: INTERNATIONAL BUSINESS MACHINES CORPORATION, Armonk, NY (US)

(21) Appl. No.: 13/289,516

(22) Filed: Nov. 4, 2011

(51) Int. Cl. G06Q 40/02

(52) U.S. Cl. 705/39

(57) ABSTRACT

Real-time microfinancing, in one aspect, concerns the fulfillment of a funding request in real time. The funding request is matched against a candidate set of funding providers based one or more criteria specified by the funding providers. The candidate set of funding providers are notified. The funds may be transferred from one or more accounts of one or more of the candidate set of funding providers to an account of the funding requester.

### FIELD

The present application relates generally to computers and computer applications, and more particularly to enabling a real-time microfinancing system, for instance, via devices such as kiosks or mobile devices.

### BACKGROUND

Microfinance is a method of funding individuals or groups via small donations or loans made from one or more parties. Existing microfinance services include Kiva (kiva dot org) and Prosper (prosper dot com). They are used to fund individuals around the world who traditionally lack access to banking services. Through these services, individuals typically request funds by specifying the amount they wish to borrow (receive), a description of their intended use of the funds, and personal information about themselves, such as their name, a photo, and/or where they live. One limitation of these services is that they cannot be used for real-time funding scenarios, such as at the time of making a purchase in a store, and they may not provide guarantees that funds have been used appropriately.

### BRIEF SUMMARY

A system for enabling microfinancing, in one aspect, may include a microfinancing module operable to execute on the processor and to receive a request for funding. The microfinancing module may be further operable to match the funding request against a candidate set of funding providers based on one or more predetermined criteria specified by the funding providers. The microfinancing module may be further operable to enable transfer of funds from one or more accounts of the candidate set of funding providers to an account of the funding requester. The system may also include a memory device for storing said one or more predetermined criteria specified by the funding providers.

A method of providing microfinancing, in one aspect, may include receiving a funding request. The method may also include matching the funding request against a candidate set of funding providers based one or more criteria specified by the funding providers. The method may further include notifying the candidate set of funding providers. The method may yet further include transferring funds from one or more accounts of one or more of the candidate set of funding providers to an account of the funding requester.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram showing components of a microfinancing system in one embodiment of the present disclosure.

FIG. 2 shows a high-level overview of a microfinancing methodology in one embodiment of the present disclosure.

FIG. 3 is a diagram illustrating example computer processor and devices on which a microfinancing in one embodiment of the present disclosure may be implemented.

FIG. 4 is a flow diagram illustrating a method of creating funding rules in one embodiment of the present disclosure.

FIG. 5 is a flow diagram illustrating a method of processing funding rules in one embodiment of the present disclosure.

### DETAILED DESCRIPTION

Requesters may be enabled to craft requests for microfinancing and receive funds from a network of microfinanciers in real-time. Microfinancing in the present disclosure refers to a method of funding, typically between individuals. For instance, microfinancing may occur between individuals without an intermediate banking or like institution being involved in the funding request and provision. There is no restriction to the amounts of funding; For purposes of this invention the amounts that are handled can be large or small. It should also be noted that the present inventions may apply not only to real currency but also to virtual currencies and instruments such as loyalty points, frequent flier miles, coupons, mobile telephone minutes, travel or event tickets, and so on. In the present disclosure the term “funds” may include any of the above instruments and/or others.

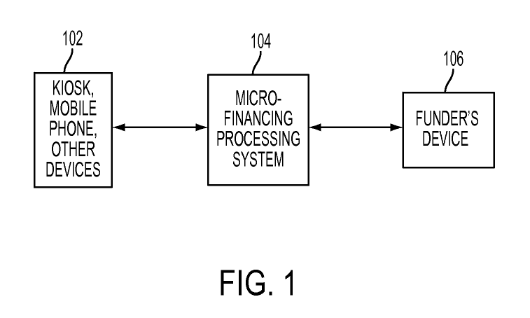

FIG. 1 is a diagram showing components of a microfinancing system in one embodiment of the present disclosure. One embodiment of the methodology of the present disclosure may use an in-store kiosk 102 to create requests and/or receive funds. In another embodiment, a mobile phone may be used. Yet in another embodiment, a microfinance-backed payment instrument (e.g. a credit card) may be used. Microfinanciers 106 may be also enabled to establish, manage, and disburse funds from a microfinance savings account via, for example, the in-store kiosk or mobile phone or web site. Other mobile or personal devices in different shapes and sizes can be used as well—including tablets, game consoles, televisions, video conferencing equipment, etc. This account can be funded from purchases made with linked payment instruments, such as credit or debit cards or the like.

The present disclosure in one embodiment introduces a system that enables real-time funding of microfinance requests coupled with a guarantee that the funds are used only for the satisfaction of that request. Enabling real-time microfinancing in one embodiment of the present disclosure requires matching microfinance requests to microfinance providers via real-time notifications and pre-established business rules. The use of real-time notifications and pre-established business rules has not been used to date in the microfinancing domain.

Functionality for two entities in one embodiment of the present disclosure is described below.

Microfinance providers 106, for instance, via a microfinance processing system 104, may establish one or more microfinance accounts used to save money or others intended for microfinancing; link existing payment instruments, such as credit or debit cards, bank accounts, loyalty programs, to these accounts; establish business rules that govern how deposits into these accounts are made based on usage of the linked payment instruments; establish business rules that govern how to respond to microfinance requests, for example, automatically or via real-time messaging.

Microfinance receivers 102 may craft a microfinance request. This request can be for a loan (e.g., funds repaid) or for charity (e.g., funds not repaid). Microfinance receivers may also specify details for how they intend to use the funds obtained by the request; specify details on their personal identity and their financial situation; specify details on acceptable loan terms (if applicable); have their request routed to one or more microfinance providers whose finance rules allow the request to be satisfied; receive funds in an appropriate format (hard currency, paper voucher, electronic funds transfer, electronic transfer of right to use, etc.) from the microfianance account(s).

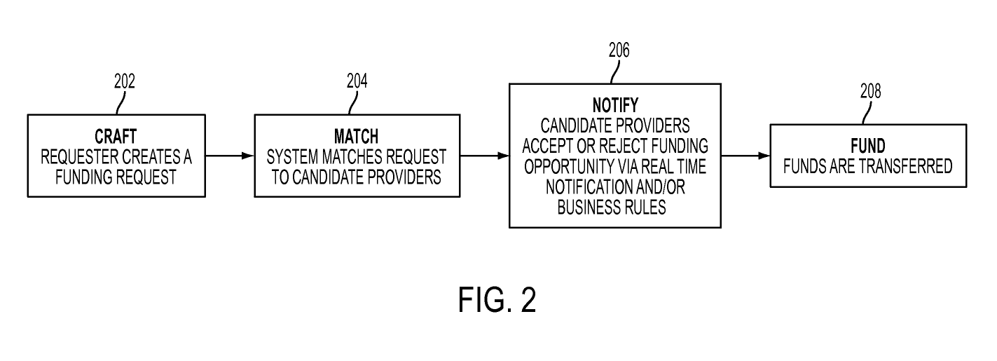

FIG. 2 illustrates an overview of the method in one embodiment for microfinancing. At 202, a requester may create a funding request. At 204, a microfinancing system may match the requester with a fund provider, for instance, based on various criteria as explained in more detail below. At 206, the microfinancing system may notify the matched one or more candidate providers. The candidate providers are thus given an option to accept or reject funding opportunity via real time notification and/or business rules. In one embodiment, one or more candidate providers may opt to fund a portion of the requested amount. Thus, in one aspect, the full amount of the request may come from multiple funders, e.g., multiple funders each accepting to fund a portion of the full amount. At 208, once accepted, the funds are transferred to the requester.

The methodology and/or system disclosed herein may enable a number of new scenarios for the organization and management of microfinancing. For example, real-time request creation and satisfaction may be enabled as described in the following scenario:
An individual creates a microfinance account linked to their credit card. They create a rule that donates $1 to this account for every purchase they make. They also create a rule that automatically funds requests from homeless people at fast food restaurants.
A homeless person goes to a fast food restaurant. They interact with a kiosk in the store that allows them to specify the food they would like to order. The kiosk is also equipped with sensors that allow the person to identify themselves (e.g., a camera and/or fingerprint scanner). The homeless person specifies their order and identifies themselves to the system. The system crafts a request for funds, which includes the person's history of prior requests.
The request is sent over the network to the microfinance system. A matching algorithm, such as an auction algorithm, may be used to find microfinance accounts that can satisfy the request. Real-time notifications (e.g., via SMS, phone calls, emails, instant messaging, chat, Twitter™, Facebook™, Google™, Skype™, other social networking systems, etc.) may be sent to the account holders to request approval for funding.
When the request is satisfied, funds are withdrawn from the appropriate microfinance accounts and used to make the purchase requested by the homeless person. In one embodiment, the kiosk may hook into the restaurant's order and payment system, e.g., the kiosk may communicate with the restaurant's order and payment system, e.g., via a network connection. In another embodiment, the kiosk prints a receipt or voucher for the purchase. In another embodiment, the kiosk may distribute or refill a pre-paid card (e.g., a gift card). In another embodiment, the kiosk distributes cash. Yet in another embodiment, an electronic transfer of rights may be performed for the funds or item that is transferred.

Microfinance Accounts

An individual can create one or more microfinance accounts into which they contribute funds. Funds can be contributed manually or automatically when purchases are made using business rules created by the account holder. These rules can be based on a variety of criteria, e.g.:
Fixed-amount contributions—contribute a fixed amount when a purchase is made, independent on the amount of the purchase
Percentage-based contributions—contribute a percentage of the purchase amount
Location-based contributions—contribute based on the location the purchase was made (e.g., “10% of all purchases made in New York City”)
Date and time-based contributions—contribute based on the date and/or time the purchase was made (e.g., “10% of all purchases made on Sundays”)
Store-based contributions—contribute based on the store in which the purchase was made (e.g., “10% of all ABC store purchases”)
Item/category-based purchase authorizations—contribute based on the items being purchased (e.g., “10% of all food purchases”)
Time-period contributions—contribute a fixed or variable amount per a selected or predetermined time period (e.g., $50 every week, 100 points per month in a loyalty account, 500 miles from a frequent flier program per month, or other fixed mechanisms such a fixed percentage of balance in a loyalty account, $3 from a gas rewards program, or expiring coupons that one doesn't plan to use per their wishlist/shopping list, etc.)

The rules may be fixed and predetermined, or may vary dynamically with one or more external conditions (e.g., contribute more if the Dow Jones is above 12,000, or contribute for a taxi ride only if the weather is cold or rainy). For example, the rules may indicate whether to provide funds based on weather conditions, e.g., funding on days with abnormal weather such as excessive rain, heat, snow, cold, etc., for the specific region. Whether such weather condition is abnormal may be determined by checking whether the weather condition for a region being considered is outside the range of average weather condition for that region on that day. As another example, the rules may indicate whether to provide funds based on market conditions such as stock market index, invididual's net worth based on stock market index on the day, and other conditions.

The microfinance system may move the funds from the user's account when the user makes the contribution or withdraws it at time of disbursement. The microfinance system may be able to “lock” assets so they are reserved for later use by the microfinance system.

Another set of business rules may specify how monies are disbursed from the account for a microfinance request. Examples may include:
Fund based on request type—specify general types of requests to fund such as food, clothing, shelter, utility bills, etc., or specific items or products.
Specific types of requesters to fund—homeless people, local entrepreneurs in a specified country, children in a specified country
Fund based on merchant or merchant type—specify specific merchants or types of merchants to fund, such as a specified franchise, restaurants, drugstores, etc.
Fund based on geographic characteristics—specify specific geographies to fund, such as a specific country or city, one's immediate vicinity, etc.
Fund based on date/time characteristics—specify specific dates and/or times to allow funding (e.g., during March 2011, only on Sundays, on one's birthday, on US government holidays, on specified religious days, etc., based on whether the day is a holiday, e.g., religious, national holidays, etc.)
Fund based on previous funding patterns—specify rules that limit the rate at which requests can be funded (e.g., one a week, ten a month, etc.), specify rules that limit the amount that can be funded (e.g., only fund requests under $10),
Fund specific individuals—specify rules that fund requests coming from a specific individual (e.g., my father, my child); this rule enables the creation of a type of sub-account on the primary account that can be used only by a particular person
Fund automatically or in real time—specify whether certain types of requests should be funded automatically, or if real-time notification and/or confirmation is required (e.g., “let me review and confirm all funding requests for homeless people”)
Fund based on how monies are to be disbursed—specify whether to fund requests if they are for hard currency, electronic transfers to an account or to a POS system, paper vouchers that are redeemed in the store, or gift cards.
   Funding rules specify conditions under which the rule is activated (e.g., by matching a funding request in one or more of the above categories), and a decision for whether the request should be funded, should not be funded, or a real-time notification should be sent to determine whether the request is funded or not. In the case a real-time notification is specified, the notification methods may also be specified (e.g., send an email, SMS, social network notification, etc.). Further, a response time window may be specified with a default decision, such that if a response is not received within the time window, the default decision is used.

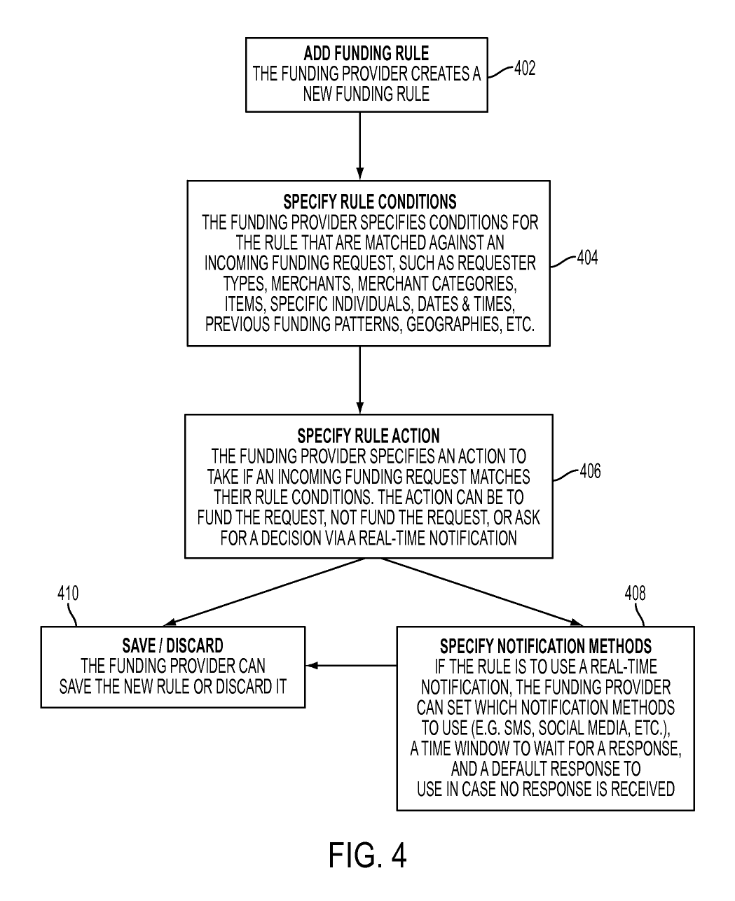

FIG. 4 is a flow diagram illustrating a method of creating funding rules in one embodiment of the present disclosure. At 402, a funding provider may create a new funding rule. For instance, the funding provider may log on via a web interface or like user interface to an account set up for the funding provider, and create such rules. Other methodology may be utilized to create rules. At 404, the funding provider specifies conditions for the rule for matching against an incoming funding request. For instance, the conditions may include requester types, merchants, merchant categories, items, specific individuals, dates and times, previous funding patterns, geographies, and/or others. At 406, the funding provider may also specify an action to take if an incoming funding request matches the conditions specified by the funding provider. For instance, the action may be to fund the request, not fund the request, or ask for a confirmation or decision via a real-time notification. At 408, the fund provider may also specify notification methods. For instance, the fund provider may set which one or more notification methods to use when notifying the fund provider, e.g., SMS, social media, and/or others. The fund provider may also set a time window to wait for a response, and a default response to use in case no response is received. At 410, the funding provider can save the new rule or discard it.

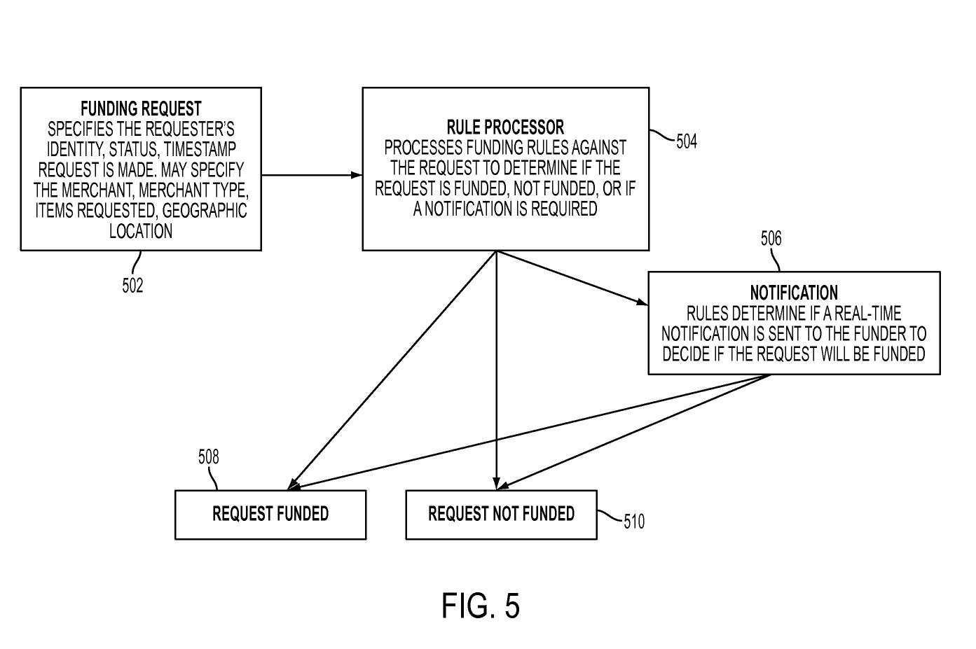

FIG. 5 is a flow diagram illustrating a method of processing funding rules in one embodiment of the present disclosure. At 502, a funding request is received. The request, for instance, may specify the requester's identify, status, and timestamp the request is made. The request may also specify the merchant, merchant type, items requested, and geographic location. At 504, a rule processor may process funding rules against the request to determine if the request is funded, not funded, or if a notification is required. The funding rules, for example, are saved in a database or the like, and includes funding rules created by funding providers. Based on the rules, the request may be funded at 508 or not funded at 510. At 506, if it is determined that a real-time notification is to be sent to the funding provider (whose rules matched the request) to decide whether the request will be funded, based on the funding provider's decision, the request may be funded at 508 or not funded at 510.

Repayment of Funds

Microfinance accounts may also have rules that govern the terms of repayment. Different repayment models may include:
The charity model, in which funds are not repaid
The loan model, in which microfinance providers specify terms on their loan, for example, including interest rates, dates of repayment, and penalties for late payments.

A microfinance system in one embodiment of the present disclosure may keep track of the details regarding how much a microfinance receiver owes in repayment, and to which microfinance providers those funds are owed.

Account Linking

In one embodiment of the present disclosure, microfinance accounts can be linked in such a way that they can be visible to other parties. For example, a group of friends may wish to link their accounts together to create a pool of money designated for a shared cause, such as earthquake victims in a specified country. The funds in linked accounts would be pooled together as a new account, with a single set of disbursement business rules. The status of this pool would also be visible to all participants, so they could see how much money is in it and where that money is going.

Microfinance Requests

Microfinance requesters may craft requests via a number of means. For instance, interfaces to the microfinancing system may include one or more of, but not limited to, in-store kiosks, smartphone applications, SMS interfaces, phone interfaces, and/or microfinance-backed payment instruments.

In-store kiosks enable microfinance requesters to input the details of their request (e.g., a food order at a fast food restaurant), attach additional notes or comments about the nature of their request (e.g., they are homeless), attach additional information about themselves (e.g., a picture captured at the kiosk, their name, other identifying information, and/or biometric information such as a fingerprint or iris scan), and how they would like funds to be disbursed (e.g., hard currency, paper voucher, electronic funds transfer, gift card), and send the request to the funding system.

Special microfinance-backed payment instruments could also be created that contain pre-programmed information about the bearer, such as their identifying information and their reason for needing microfinancing (e.g., they are homeless, they need food stamps, etc.). These instruments may be issued by an official authority, such as a government agency, which can verify the identity and status of the bearer. These instruments may also be created in response to specific disasters, such as an “Earthquake Victim Card”. As with other payment instruments, these instruments may be created to have an expiration date (e.g., “only valid from March to May 2011”). Also, for example, it may be specified that the microfinance requests generated using this instrument be limited to only making electronic funds transfers.

Microfinance Request Funding

Microfinance requests may be routed to a funding system. This funding system may run an algorithm that finds one or more accounts that would allow the request to be funded based on the account holders' funding rules. It then runs an algorithm (e.g., an auction algorithm) to determine which accounts fund the request and for how much. For instance, automatic process may select one or more fund accounts based on different criteria or rules associated with the fund accounts. This algorithm may have a configurable timeout limit to prevent stalling the payment process; e.g., kiosk requests may time out after a minute, whereas microfianance card requests may time out after 15 seconds. A single request may be funded by multiple accounts. In the event that no accounts can satisfy a funding request, the request may be denied.

If a request is satisfied, the kiosk could disburse the funds by, for example, transferring funds into the specified account via an electronic funds transfer. Funds may be also distributed by tying into the point of sale (POS) system and transferring the funds electronically; in this case a paper receipt of purchase may be distributed to the fund requester. Funds may be also distributed by issuing a paper voucher that can be ready by the POS terminal with details of the funding. Still yet, funds may be distributed by issuing hard currency; in this case, there might be no verification sent to the funder. Funds may also be distributed via a gift card, e.g., issuing a gift card in the amount of funding.

Real-time Funding Notification, Authorization, and Verification

During the matching step, funders may have rules that specify to contact them in real-time to determine if they would fund a request. For instance, this contact can be made using any two-way communications technology such as but not limited to: SMS messages, for instance, in which the account holder may receive an SMS with details of the funding request and can reply to approve or not approve the request; Email, which operates similarly to SMS messages, except the message is transmitted via email; Phone call, for instance, in which an automated system can call the microfinance account holder's phone and provide the details of the request by voice, for instance, also in which speech recognition or the like may be used to determine if the account holder wants to fund the request or not for automatic processing; Smartphone application, for instance, in which a smartphone application (e.g., a digital wallet) can use a push notification service or can poll for microfinance requests; Social network notification, for instance, in which a notification is sent to the user on a social network (e.g., Facebook™, Twitter™, Google+™) Authorizations may be made through a user interface in the application or software (e.g., by showing ‘fund’ or ‘do not fund’ buttons)

In addition, if a fund request is satisfied electronically, a notification may be sent to the funder verifying that the funds have been used appropriately (e.g., when the funds transfer is made).

Reporting and Analytics

An embodiment of the present system may maintain logs and records pertaining to the activity in and usage of a microfinance account, and the creation and servicing of microfinance requests. From these data, microfinance providers may be enabled see how much they have loaned/given, the parties to whom they have given, loan repayment rates, and earned income from loan interest. Conversely, microfinance receivers may see how much they have received, such as for income tax purposes. Global statistics could also be computed, such as how often requests are funded, which types of requests are most likely to be funded, how often loans are repaid, and how much has been given for charitable causes.

Implementation

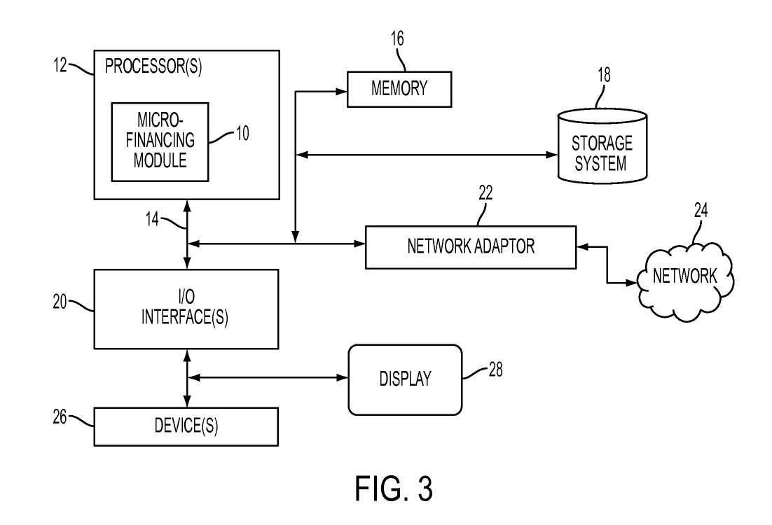

FIG. 3 illustrates a schematic of an example computer or processing system that may implement the microfinancing system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, mobile phones, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a microfinancing module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces. For instance, various rules and criteria, fund accounts and provider and requester information may be stored in the storage system 18.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as PHP, Perl, VBS or similar languages, and/or functional languages such as Lisp and ML and logic-oriented languages such as Prolog, and/or web languages and/or libraries such as Javascript, Dojo, jQuery or similar languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A system for enabling microfinancing, comprising:
a processor;
a microfinancing module operable to execute on the processor and to receive a request for funding, the microfinancing module further operable to match the funding request against a candidate set of funding providers based on one or more predetermined criteria specified by the funding providers, the microfinancing module further operable to enable transfer of funds from one or more accounts of the candidate set of funding providers to an account of the funding requester; and
a memory device for storing said one or more predetermined criteria specified by the funding providers.

2. The system of claim 1, wherein the microfinancing module further notifies the candidate set of funding providers and based on approval of the candidate set of funding providers, enables the transfer of funds.

3. The system of claim 1, wherein the microfinancing module further tracks repayments made from the funding requester to the funding providers.

4. The system of claim 1, wherein a microfinance account is established for funding the microfinance funding request, and wherein a payment instrument is linked to the microfinance account, the microfinancing module using one or more rules to deposit funds into the microfinance account, and wherein the one or more rules include depositing based on one or more of fixed-amount deposits, percentage-based deposits, location-based deposits, date and time-based deposits, store-based deposits, item-based purchase deposits, net individual worth deposits, or combinations thereof.

5. The system of claim 1, wherein the one or more predetermined criteria include cause type, request type, merchant type, geographic characteristics, date or time characteristics, market conditions, weather conditions, previous funding patterns, funder-specified individuals.

6. The system of claim 1, wherein multiple microfinance accounts are linked together to form a pool of microfinance funds with a single set of rules governing the use of the pool of microfinance funds.

7. The system of claim 1, wherein operations of authentication, creating funding requests, receiving funds, and managing funding accounts, rules, and preferences are performed via a mobile phone application.

8. The system of claim 1, wherein a web service is used to manage operations of authentication, creating funding requests, receiving funds, and managing funding accounts, rules, and preferences.

9. The system of claim 1, wherein a microfinance-backed payment instrument with pre-programmed information associated with a bearer of the microfinance-backed payment instrument is used to manage operations of creating funding requests and receiving funds.

10. The system of claim 1, wherein the funding is disbursed via an electronic fund transfer to a microfinance account, an electronic transfer to a linked POS system, hard currency, paper voucher, gift card, or combinations thereof.

11. The system of claim 1, wherein the fund provider is notified when an electronic transfer has been completed.

12. The system of claim 1, wherein the fund providers specify one or more terms of repayment, wherein specification includes whether funds are charitable donations and need not be repaid, whether funds are loans and are repaid according to specified terms and conditions, or combinations thereof.

13. The system of claim 1, wherein the microfinance module tracks how much fund a recipient owes one or more of the funding providers, computes interest on owed balances, and handles repayments.

14. The system of claim 1, wherein information associated with funding statistics is collected.

15. A method of providing microfinancing, comprising:
receiving a funding request;
matching the funding request against a candidate set of funding providers based on one or more criteria specified by the funding providers;
notifying the candidate set of funding providers; and
transferring funds from one or more accounts of one or more of the candidate set of funding providers to an account of the funding requester.

16. The method of claim 15, wherein the step of notifying the candidate set of funding providers includes determining whether one or more of the candidate set of funding providers specified to be notified, and if it is determined that said one or more of the candidate set of funding providers specified to be notified, notifying said one or more of the candidate set of funding providers.

17. The method of claim 16, wherein the step of transferring funds is performed based on approval from said one or more of the candidate set of funding providers.

18. The method of claim 15, wherein the funds include real currency or virtual currency or combination thereof.

19. The method of claim 18, wherein the virtual currency includes one or more of loyalty points, frequent flier miles, telephone minutes, coupons, event tickets, or travel tickets or combinations thereof.

20. The method of claim 15, wherein the one or more predetermined criteria include cause type, request type, merchant type, geographic characteristics, date or time characteristics including holidays, market conditions including individual net worth, weather conditions, previous funding patterns, funder-specified individuals.

21. A computer readable storage medium storing a program of instructions executable by a machine to perform a method of providing microfinancing, comprising:
receiving a funding request;
matching the funding request against a candidate set of funding providers based one or more criteria specified by the funding providers;
notifying the candidate set of funding providers; and
transferring funds from one or more accounts of one or more of the candidate set of funding providers to an account of the funding requester.

22. The computer readable storage medium of claim 21, wherein the step of notifying the candidate set of funding providers includes determining whether one or more of the candidate set of funding providers specified to be notified, and if it is determined that said one or more of the candidate set of funding providers specified to be notified, notifying said one or more of the candidate set of funding providers.

23. The computer readable storage medium of claim 22, wherein the step of transferring funds is performed based on approval from said one or more of the candidate set of funding providers.

24. The computer readable storage medium of claim 21, wherein the funds include real currency or virtual currency or combination thereof, wherein the virtual currency includes one or more of loyalty points, frequent flier miles, telephone minutes, coupons, event tickets, or travel tickets.

25. The computer readable storage medium of claim 22, wherein the one or more predetermined criteria include cause type, request type, merchant type, geographic characteristics, date or time characteristics including holidays, market conditions including individual net worth, weather conditions, previous funding patterns, funder-specified individuals.
